(19) United States
(12) Patent Application Publication
(10) Pub. No.: US 2011/0157073 A1
(43) Pub. Date: Jun. 30, 2011

(54) TOUCH STRUCTURE AND TOUCH DISPLAY APPARATUS COMPRISING THE SAME

(75) Inventors: San-Long LIN, Hsinchu City (TW); Pei-Lin HUANG, Hsinchu City (TW)

(73) Assignee: PRIME VIEW INTERNATIONAL CO., LTD, Hsinchu (TW)

(21) Appl. No.: 12/788,012

(22) Filed: May 26, 2010

(30) Foreign Application Priority Data
Dec. 28, 2009 (TW) 098145279

(51) Int. Cl. G06F 3/042

(52) U.S. Cl. 345/174

(57) ABSTRACT

A touch structure and a touch display apparatus comprising the same are provided. The touch display apparatus further comprises a touch controller which is electrically connected to the touch structure. The touch structure comprises a display panel, a transparent conductive film and a conductor. The display panel has a light-tight region. A resistance coefficient of the conductor is smaller than a resistance coefficient of the transparent conductive film. The conductor is disposed between the light-tight region of the display panel and the transparent conductive film to form a signal conduction path. The transparent conductive film generates a touch signal when being touched. The touch signal is adapted to be conducted to the touch controller via the signal conduction path so that the touch controller may operate in response to the touch signal.

### CROSS-REFERENCES TO RELATED APPLICATIONS

This application claims priority to Taiwan Patent Application No. 098145279 filed on Dec. 28, 2009.

### BACKGROUND OF THE INVENTION

1. Field of the Invention

The present invention provides a touch structure and a touch display apparatus comprising the same. More particularly, the present invention provides a touch structure with a low-resistance signal conduction path and a touch display apparatus comprising the same.

2. Descriptions of the Related Art

As an apparatus that is attached to a display device, touch panels provide an interaction between users and display devices when being slightly depressed by a finger or a touch pen. Touch panels have been widely applied in the following apparatuses: (1) portable information electronic products, consumer electronic products and communication electronic products, such as personal digital assistants (PDAs), flat panel computers, digital video cameras, information home appliances, 3G mobile phones and the like; (2) financial or commercial applications, such as automatic teller machines (ATMs), sale systems, remote video conferences and telephone terminal systems; (3) industrial applications, such as factory automated control systems, central monitoring systems and workstation operating systems; and (4) public information applications, such as guided services, presentations and data queries provided in airports, stations or marketplaces.

For example, in a surface capacitive touch panel, a layer of oxidized metal is plated on a substrate to form a transparent conductive film which, together with the substrate, may be regarded as the touch panel. Furthermore, the voltage of the touch panel is supplied from the four corners of the touch panel to the transparent conductive film to generate a uniform electric field on the surface of the touch panel. By means of electric field variations caused by the electrostatic induction between the human finger and the electric field, a touch signal can be generated to a touch controller so that the touch controller can determine the coordinates of the touch position on the touch panel according to the touch signal.

However, the transparent conductive film is made to have a high resistance coefficient, which causes the touch signal generated by the touch panel to attenuate in a conduction path to the touch controller. If the transparent conductive film has a larger area, attenuation of the touch signal will become more significant, which is unfavorable for the touch controller to determine the coordinates of the touch position.

Accordingly, there is still an urgent need in the art to provide a solution that can effectively restrain the attenuation of the signal resulting from the high resistance coefficient of the transparent conductive film to improve the accuracy in determining the coordinates of the touch position.

### SUMMARY OF THE INVENTION

An objective of the present invention is to provide a touch structure adapted for a touch display apparatus. The touch display apparatus comprises a touch controller electrically connected to the touch structure. The touch structure comprises a display panel, a transparent conductive film and a conductor. The display panel has a light-tight region. The transparent conductive film has a conductive pattern electrically connected to the touch controller and is adapted to generate a touch signal in response to a touch. The conductor is disposed between the light-tight region of the display panel and the transparent conductive film and electrically connected to the conductive pattern to form a signal conduction path. The touch signal is adapted to be conducted to the touch controller via the signal conduction path so that the touch controller may operate in response to the touch signal. A resistance coefficient of the conductor is smaller than a resistance coefficient of the transparent conductive film.

Another objective of the present invention is to provide a touch display apparatus, which comprises a touch controller and a touch structure electrically connected to the touch controller. The touch structure comprises a display panel, a transparent conductive film and a conductor. The display panel has a light-tight region. The transparent conductive film has a conductive pattern electrically connected to the touch controller and is adapted to generate a touch signal in response to a touch. The conductor is disposed between the light-tight region of the display panel and the transparent conductive film and electrically connected to the conductive pattern to form a signal conduction path. The touch signal is adapted to be conducted to the touch controller via the signal conduction path so that the touch controller may operate in response to the touch signal. A resistance coefficient of the conductor is smaller than a resistance coefficient of the transparent conductive film.

In summary, according to the present invention, by disposing a conductor with a resistance coefficient smaller than the resistance coefficient of a conductive film between the light-tight region of a display panel and the transparent conductive film, a signal conduction path is formed to reduce the attenuation of the signal resulting from the transmission process and to improve the accuracy in determining the coordinates of a touch position. Thereby, shortcomings of the prior art are effectively overcome.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a top view of the embodiment of the present invention; and

FIG. 2 is a cross-sectional view of the embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purposes of illustration rather than limitation. It should be appreciated that in the following embodiments and the attached drawings, elements unrelated to the present invention are omitted from depiction; and dimensional relationships among individual elements in the attached drawings are illustrated only for ease of understanding, but not to limit the actual scale.

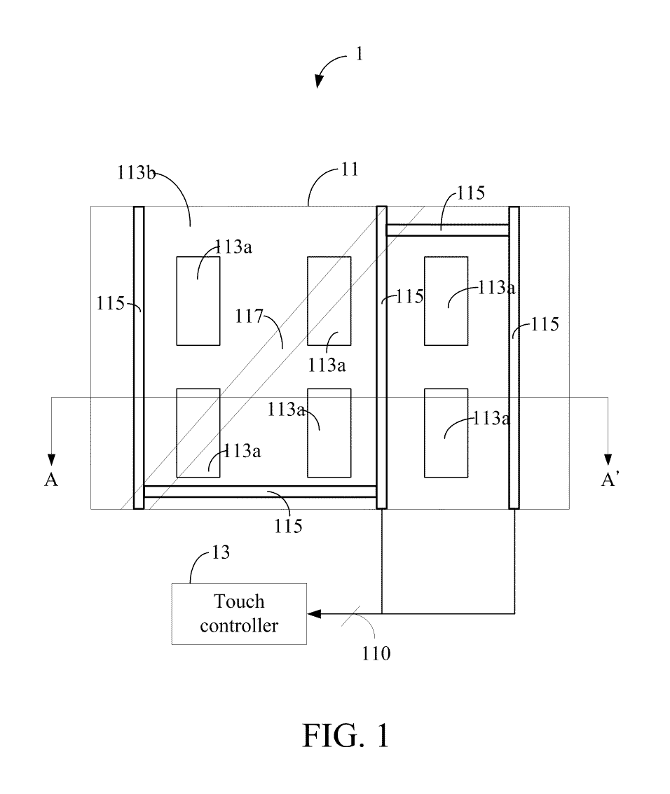

An embodiment of the present invention is shown in FIG. 1, which is a top view of a touch display apparatus 1. The touch display apparatus 1 comprises a touch structure 11 and a touch controller 13 electrically connected to the touch structure 11. The touch structure 11, which is a surface capacitive touch structure, is adapted to generate a touch signal 110 in response to a touch of a user and to conduct the touch signal 110 to the touch controller 13 so that the touch controller 13 may operate in response to the touch signal 110, for example, to determine the touch position according to the touch signal 110.

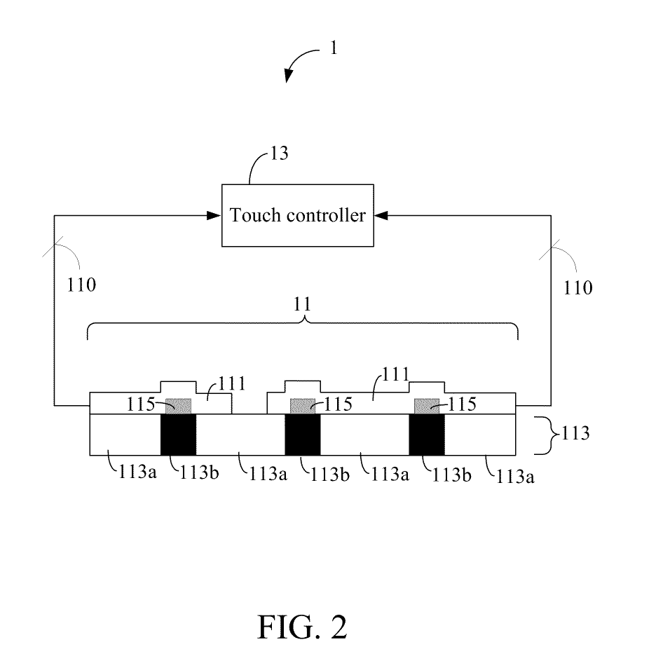

In more detail, FIG. 2 illustrates a cross-sectional view of the touch structure 11 along a solid line A-A′. The touch structure 11 comprises a transparent conductive film 111, a display panel 113 and a conductor 115. The display panel 113 has a display region 113a and a light-tight region 113b, wherein the display region 113a is configured to jointly present a frame for the user to watch. The transparent conductive film 111 has a conductive pattern 117 electrically connected to the touch controller 13. The formation of the conductive pattern 117 on the transparent conductive film 111 can be achieved by conventional technologies, so this will not be further described herein.

As shown in FIG. 2, the conductor 115 is disposed between the light-tight region 113b of the display panel 113 and the transparent conductive film 111, and is electrically connected to the conductive pattern 117 of the transparent conductive film 111 to form a signal conduction path. Moreover, in this embodiment, the resistance coefficient of the conductor 115 is smaller than the resistance coefficient of the transparent conductive film 111 so that the overall resistance of the signal conduction path is reduced.

Furthermore, as can be known from the above description, the touch structure 11 is a surface capacitive touch structure, so the transparent conductive film 111 in this embodiment may be made of indium tin oxide (ITO). When a voltage is applied, the transparent conductive film 111 generates an electric field, which is adapted to vary in response to a touch of a user to generate a touch signal 110. The touch signal 110 is adapted to be conducted to the touch controller 13 via the signal conduction path formed by the conductor 115 and the conductive pattern 117 of the transparent conductive film 111 so that the touch controller 13 may operate in response to the touch signal 110, for example, to determine the touch position according to the touch signal 110.

Furthermore, as the conductor 115 is disposed between the light-tight region 113b of the display panel 113 and the transparent conductive film 111, the material of the conductor 115 will not affect the imaging of the display region 113a, making the selection of the material of the conductor 115 more flexible. In this embodiment, the conductor 115 is made of light-tight metal. More specifically, the material of the light-tight metal may be selected from gold, aluminum, chromium, and combinations thereof; however, the material of the light-tight metal may also be adjusted depending on the practical applications, rather than being merely limited thereto.

In summary, according to the present invention, by disposing a conductor with a resistance coefficient smaller than the resistance coefficient of a conductive film between a light-tight region of a display panel and the transparent conductive film, a signal conduction path is formed to reduce the attenuation of the signal resulting from the transmission process and to improve the accuracy in determining the coordinates of a touch position. Thereby, shortcomings of the prior art are effectively overcome.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A touch structure being adapted for a touch display apparatus, the touch display apparatus comprising a touch controller electrically connected to the touch structure, the touch structure comprising:
a display panel, having a light-tight region;
a transparent conductive film, having a conductive pattern electrically connected to the touch controller and being adapted to generate a touch signal in response to a touch; and
a conductor, being disposed between the light-tight region of the display panel and the transparent conductive film and electrically connected to the conductive pattern to form a signal conduction path, the touch signal being adapted to be conducted to the touch controller via the signal conduction path so that the touch controller may operate in response to the touch signal;
wherein a resistance coefficient of the conductor is smaller than a resistance coefficient of the transparent conductive film.

2. The touch structure as claimed in claim 1, wherein a material of the transparent conductive film is indium tin oxide (ITO).

3. The touch structure as claimed in claim 1, wherein the touch structure is a surface capacitive touch structure, and the transparent conductive film generates an electric field adapted to vary in response to the touch to generate the touch signal.

4. The touch structure as claimed in claim 1, wherein the conductor is made of light-tight metal.

5. The touch structure as claimed in claim 4, wherein the material of the light-tight metal is selected from a group consisting of: gold, aluminum, chromium and combinations thereof.

6. A touch display apparatus, comprising:
a touch controller; and
a touch structure, being electrically connected to the touch controller and comprising:
a display panel, having a light-tight region;
a transparent conductive film, having a conductive pattern electrically connected to the touch controller and being adapted to generate a touch signal in response to a touch; and
a conductor, being disposed between the light-tight region of the display panel and the transparent conductive film and electrically connected to the conductive pattern to form a signal conduction path, the touch signal being adapted to be conducted to the touch controller via the signal conduction path so that the touch controller may operate in response to the touch signal;
wherein a resistance coefficient of the conductor is smaller than a resistance coefficient of the transparent conductive film.

7. The touch display apparatus as claimed in claim 6, wherein a material of the transparent conductive film is indium tin oxide (ITO).

8. The touch display apparatus as claimed in claim 6, wherein the touch structure is a surface capacitive touch structure, and the transparent conductive film generates an electric field adapted to vary in response to the touch to generate the touch signal.

9. The touch display apparatus as claimed in claim 6, wherein the conductor is made of light-tight metal.

10. The touch display apparatus as claimed in claim 9, wherein the material of the light-tight metal is selected from a group consisting of: gold, aluminum, chromium and combinations thereof.
